(19) United States
(12) Patent Application Publication
(10) Pub. No.: US 2010/0227979 A1
(43) Pub. Date: Sep. 9, 2010

(54) PROCESS FOR HYDROGENATING POLYMERS AND HYDROGENATION CATALYSTS SUITABLE THEREFOR

(75) Inventors: Bram Willem Hoffer, Heidelberg (DE); Ekkehard Schwab, Neustadt (DE); Jochem Henkelmann, Mannheim (DE); Zsolt Jozsef Szarka, Vaihingen (DE); Hubertus Peter Bell, Mannheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/161,349

(22) PCT Filed: Jan. 22, 2007
(86) PCT No.: PCT/EP07/50586

§ 371 Date: Jul. 18, 2008

(30) Foreign Application Priority Data
Jan. 30, 2006 (EP) 06101016.1

(51) Int. Cl. C08F 8/04

(52) U.S. Cl. 525/338; 977/700

(57) ABSTRACT

A process for hydrogenating polymers which have C—C double bonds or C—N multiple bonds using a hydrogenation catalyst which comprises a megaporous substrate and a metal or precursor thereof which catalyzes the hydrogenation and has been deposited onto carbon nanofibers.

The present invention relates to a process for hydrogenating polymers which have C—C double bonds or C—N multiple bonds using a hydrogenation catalyst which comprises a megaporous substrate and a metal or precursor thereof which catalyzes the hydrogenation and has been deposited onto carbon nanofibers.

In many cases, it is of interest to prepare polymers with saturated side chains, i.e., for example, side chains which comprise an ethyl group or an aminomethyl group. Such polymers can be used, for example, for the production of cosmetics, for temporary corrosion protection, as crosslinkers for adhesives or for dye fixing during washing. However, preparation of such polymers in one step is generally not simple. For instance, it is difficult to polymerize monomers such as 3-aminopropene or 1-butene, for example, by a free-radical route.

It has therefore been proposed first to polymerize readily polymerizable monomers, for example 1,3-butadiene or acrylonitrile, or to copolymerize them with other monomers, and to hydrogenate the remaining C—C double bonds or C—N multiple bonds in a separate step. In order to avoid contaminations of the corresponding product, i.e. of the hydrogenated polymer, with catalyst residues, it is necessary to use an immobilized catalyst.

Immobilized catalysts can be used, for example, in suspension, as fixed bed catalysts or in the form of monoliths.

Even in the case of use of hydrogenation catalysts in a suspension process, it is difficult in many cases to separate hydrogenated polymer and hydrogenation catalyst particles after the reaction has ended. A removal of the hydrogenated polymer from hydrogenation catalyst particles thus succeeds only incompletely in many cases, and dark spots remain in the hydrogenated polymer.

In Catal. Rev.—Sci. Eng. 2000, 42, 481 ff., De Jong et al. propose preparing a catalyst by depositing a metal or precursor thereof which catalyzes the hydrogenation onto carbon nanotubes and using a catalyst thus prepared in a suspension process. However, the removal of catalyst after the reaction has ended is difficult.

Nor is the use of a fixed bed catalyst free of disadvantages. When a fixed bed hydrogenation catalyst is prepared by using a support with micropores, insufficient diffusion of the viscous polymers which have C—C double bonds or C—N multiple bonds into the micropores is observed, and, associated with this, unsatisfactory activity of the catalyst in question. When, in contrast, a support having macropores is used, as described in WO 98/22214 and EP 0 813 906, an unsatisfactory activity of the catalyst is likewise observed, which is generally associated with the low active surface area.

EP-A 1 040 137 proposes preparing hydrogenation catalysts based on a monolith with megapores. Monoliths are known for high (hydrogen) gas/liquid mass transfer rates with low energy input. To this end, a catalytically active metal is deposited onto a monolith with megapores. However, the space-time yield of the corresponding catalyst is unsatisfactory. When attempts are made to deposit a finer-pore material on the monolith by means of a so-called washcoat, unsatisfactory conversions are found for diffusion reasons.

It is thus an object of the invention to provide a process by which polymers with C—C double bonds or C—N multiple bonds can be hydrogenated in good space-time yield. It is a further object of the invention to provide a process for preparing hydrogenation catalysts. Finally, it is an object of the invention to provide uses of hydrogenation catalysts.

Accordingly, the process defined at the outset has been found.

In the context of the present invention, pores having a mean diameter below 2 nm are also known as micropores, pores having a mean diameter in the range from 2 to 50 nm also as mesopores, and pores having a mean diameter in the range from 50 nm to 1 μm also as macropores. The mean diameter of megapores is preferably in the range from 0.1 to 10 mm, preferably from 0.5 to 2 mm, determined, for example, visually or by microscopic methods.

The process according to the invention can be carried out as a process for partial or preferably quantitative hydrogenation of polymers which have C—C double bonds or C—N multiple bonds. The process according to the invention is preferably performed as a process for quantitatively or almost fully hydrogenating polymers which have C—C double bonds or C—N multiple bonds, for example C—N double bonds and especially nitrile groups, i.e. less than 5 mol %, more preferably from 0.01 to 1 mol %, of the C—C double bonds or C—N multiple bonds present in the polymer used remain intact.

In one variant of the present invention, the process according to the invention can be carried out in such a way that the starting material is a polymer which has C—C double bonds and C—N multiple bonds, and the C—N multiple bonds are hydrogenated selectively.

The means for hydrogenation used is preferably gaseous hydrogen.

In the context of the present invention, polymers which have C—C double bonds or C—N multiple bonds comprise not just homopolymers but also copolymers of such monomers which have C—C double bonds or C—N multiple bonds which are not involved in the actual polymerization or copolymerization. Examples of such monomers are isoprene, chloroprene and especially acrylonitrile and 1,3-butadiene.

In the context of the present invention, polymers which have C—C double bonds or C—N multiple bonds are understood to mean those polymers which have, on average, at least one C—C double bond or C—N multiple bond per molecule.

In a preferred embodiment of the present invention, aromatics, for example phenyl rings which can be introduced into polymers by (co)polymerization of, for example, styrene or α-methylstyrene, are not included in C—C double bonds.

The process according to the invention is preferably a process for selectively hydrogenating polymers which have C—C double bonds or C—N multiple bonds, in such a way that olefinic C—C double bonds or C—N multiple bonds are hydrogenated when the process according to the invention is performed, but aromatic systems, such as phenyl rings for example, are not.

In one embodiment of the present invention, polymers which have C—C double bonds or C—N multiple bonds have a molecular weight M_{w} in the range from 2000 to 2 000 000 g/mol, preferably from 3500 to 1 000 000 g/mol, more preferably from 4000 to 250 000 g/mol.

The process according to the invention is carried out using at least one hydrogenation catalyst. The hydrogenation catalyst used may comprise one or more catalytically active species. Catalytically active species may be derived from one or more different metals.

A hydrogenation catalyst in the context of the present invention comprises:

a megaporous substrate,

carbon nanofibers,

and metal or precursor thereof which catalyzes the hydrogenation and has been deposited onto carbon nanofibers.

Megaporous substrates are known as such. In the context of the present invention, megaporous substrates are preferably those substrates which are dimensionally stable not just at room temperature but also at temperatures up to 300° C., preferably up to 500° C., i.e. do not change shape in the course of heating to up to 300° C., preferably up to 500° C., determinable, for example, by visual inspection. In the context of the present invention, megaporous substrates generally have a foam-like structure, i.e. they have predominantly open-cell pores which can be shaped like channels. The mean diameter of the pores of megaporous substrates in the context of the present invention is preferably in the range from 0.1 to 10 mm, preferentially from 0.5 to 2 mm, determined, for example, visually or by microscopic methods. The shape of the megapores of megaporous substrates may be regular or irregular, and in each case different or predominantly similar.

In one embodiment of the present invention, megaporous substrate comprises a plurality of packed films in a distance fixed by spacers, for example, in which case the films may be flat or corrugated and the films may be stacked or rolled one on top of another.

In one embodiment of the present invention, the megaporous substrate is a monolith, i.e. the megaporous substrate used is a monolith. Monoliths and their use for preparing catalysts are known as such; see, for example, A. Cybulski et al., Catal. Rev.—Sci. Eng. 1994, 36, 179-270. In the context of the present invention, monoliths may be of metallic or preferably ceramic material and comprise a plurality of parallel tubes, for example from 10 to 1000 parallel tubes, whose walls may be permeable or preferably impermeable to solutions of polymer to be hydrogenated, more preferably as wire mesh honeycomb monolith structure or as foam monolith structure.

In one embodiment of the present invention, the megaporous substrate is attrition-resistant, i.e. less than 1% by weight of the megaporous material can be loosened or removed by scratching with the fingernail.

In one embodiment of the present invention, the megaporous substrate is a monolith of ceramic material, for example silicon carbide or silicon nitride, and especially ceramic oxidic material, for example aluminum oxide, in particular α-Al₂O₃, SiO₂, titanium dioxide, zirconium, mullite, spinels, mixed oxides of, for example, lithium and aluminum or aluminum and titanium, and especially cordierite, 2 MgO.5 SiO₂.2 Al₂O₃. Another preferred substrate is formed essentially from carbon; see, for example, Vergunst et al., Catal. Rev.—Sci. Eng. 2001, 43, 291. In one embodiment of the present invention, the megaporous substrate has a porosity in the range from 30 to 95%, preferably from 70 to 90%, determined, for example, mathematically or by measuring the water uptake.

In one embodiment of the present invention, megaporous substrate has a cell density in the range of up to 20 tubes per linear cm, determined on the cross section of the megaporous substance, preferably from 5 to 10 tubes per linear cm.

In one embodiment of the present invention, the tubes of megaporous substance have a mean diameter in the range from 0.1 to 10 mm, preferably from 0.5 to 2 mm, and a mean length in the range from 5 cm to 2 m, preferably from 10 cm to 1 m.

In the context of the present invention, hydrogenation catalysts further comprise carbon nanofibers.

In the context of the present invention, carbon nanofibers consist essentially of carbon. In the context of the present invention, carbon nanofibers have a thread-like appearance, and the threads may be elongated or preferably entangled.

In one embodiment of the present invention, carbon nanofibers may have a mean diameter in the range from 3 to 100 nm and a mean length in the range from 0.1 to 1000 μm, the mean length generally being greater than the mean diameter, preferably at least twice as great.

Carbon nanofibers can be prepared by processes known per se. For example, a volatile carbon compound, for example methane or carbon monoxide, acetylene or ethylene, or a mixture of volatile carbon compounds, for example synthesis gas, can be decomposed in the presence of one or more reducing agents, for example hydrogen and/or a further gas, for example nitrogen. Suitable temperatures for decomposition are, for example, in the range from 400 to 1000° C., preferably from 500 to 800° C.

Suitable pressure conditions for the decomposition are, for example, in the range from standard pressure to 100 bar, preferably to 10 bar.

In one embodiment, the decomposition of volatile carbon compounds is carried out in the presence of a decomposition catalyst, for example Fe, Co or preferably Ni, which has been deposited on the megaporous substance. For example, from 0.5 to 50% by weight, preferably from 2 to 20% by weight of decomposition catalyst may be deposited on the megaporous substance, based on megaporous substance. Fe, Co and in particular Ni can be deposited with preference by impregnating the megaporous substance with a preferably aqueous solution of a compound of Fe, Co or in particular

Ni, for example the sulfate, nitrate, chloride or acetate, for example contacting by spraying and preferably by impregnating, then reacting with a reducing agent, for example urea (others) and then calcining, for example at temperatures in the range from 400 to 700° C.

In one embodiment of the present invention, hydrogenation catalysts comprise a monolith as the megaporous substrate on which carbon nanofibers have been deposited, for example in a layer which is, on average, from 100 nm to 5 μm thick, preferably from 200 nm to 2 μm.

In the context of the present invention, hydrogenation catalysts further comprise at least one metal or precursor thereof which catalyzes the hydrogenation and has been deposited onto carbon nanofibers. Examples include the metals of group of 7 to 11 of the Periodic Table of the Elements, preferably Mn, Re, Rh, Fe, Co, Ni, Pd, Pt, Ru, Ag, Au and in particular Ru, and mixtures of the aforementioned metals.

In one embodiment of the present invention, hydrogenation catalysts in the context of the present invention comprise at least one further metal or precursor thereof as a cocatalyst, likewise deposited on the carbon nanofibers, for example of group 6 to 7 of the Periodic Table of the Elements.

Precursors are understood to mean those compounds of the hydrogenation-catalyzing or -cocatalyzing metal in question which are themselves not catalytically active but are converted to the catalytically active phase under the conditions of the process according to the invention.

The hydrogenation-catalyzing metal may be the same as the decomposition catalyst or preferably different.

The hydrogenation-catalyzing metal and, if appropriate, cocatalyst have been deposited onto carbon nanofibers. This is understood to mean that carbon nanofibers are contacted, for example impregnated, with a preferably aqueous solution of a metal which catalyzes the hydrogenation, preferably by spraying and more preferably by impregnating, and then reduced with the aid of a reducing agent to the metal in question or, if appropriate, its precursor. This can be followed by heating, for example to temperatures in the range from 200 to 500° C.

In one embodiment of the present invention, the hydrogenation catalyst is essentially free of micropores, i.e. no micropores are detectable by N₂ adsorption methods.

In one embodiment of the present invention, hydrogenation catalyst used in the process according to the invention comprises

from 0 to 25% by weight, preferably from 2 to 20% by weight of decomposition catalyst,

from 2 to 25% by weight, preferably from 5 to 20% by weight of carbon nanofibers and

from 0.5 to 10% by weight, preferably to 5% by weight of metal or precursor thereof which catalyzes the hydrogenation,

from 0 to 10% by weight, preferably from 0.5 to 5% by weight of cocatalyst,

based in each case on megaporous substrate.

In one embodiment of the present invention, the process according to the invention is carried out at temperatures in the range from 100 to 300° C., preferably from 150 to 250° C.

In one embodiment of the present invention, the process according to the invention is carried out at a pressure in the range from 50 to 300 bar, preferably from 100 to 250 bar.

In one embodiment of the present invention, the process according to the invention is carried out using a solvent which is liquid under the process conditions. Particularly suitable examples are toluene, ethylbenzene, ethers such as tetrahydrofuran (THF) and 1,4-dioxane, and alcohols such as methanol and ethanol, especially so-called anhydrous alcohols. It is also possible to use mixtures of two or more solvents which are preferably both liquid under the process conditions, for example mixtures of ethylbenzene and toluene.

In one embodiment of the present invention, the process according to the invention is carried out in such a way that polymer which has C—C double bonds or C—N multiple bonds is dissolved in a solvent which is liquid under the process conditions. For example, from 5 to 15% by weight of solution of polymer which has C—C double bonds or C—N multiple bonds can be used. Hydrogen is injected and the solution thus formed is passed through hydrogenation catalyst prepared as described above, for example with a mean contact time in the range from 10 to 24 hours, preferably from 14 to 18 hours.

In a specific embodiment of the present invention, the procedure is to initially charge hydrogenation catalyst in an autoclave and to add polymer solution and to establish a hydrogen pressure of about 50 bar. Thereafter, the temperature is increased up to the preferred reaction temperature, for example from 100 to 300° C., preferably from 150 to 250° C. The pressure can then be established, for example, within the range from 50 to 300 bar.

The process according to the invention can be carried out particularly efficiently in continuous form.

In a specific embodiment of the present invention, the hydrogenation catalyst is prepared by a process comprising the following steps:
(c) depositing carbon nanofibers on a megaporous substance,
(e) impregnating with a solution of at least one compound of a metal which catalyzes hydrogenations,
(f) calcining.

For the deposition of carbon nanofibers in step (c), the procedure may be as described above.

For the calcination in step (f), it is possible, for example, to heat at a temperature in the range from 200 to 1000° C., preferably from 300 to 800° C., over a period of from 10 minutes to 24 hours, for example statically under air or in an air stream.

In a specific embodiment of the present invention, the hydrogenation catalyst is prepared by a process which, before step (c), comprises a step of
(a) washcoating with a material which forms macropores.

To perform step (a), it is possible, for example, to carry out a washcoating with a material which forms macropores, for example after thermal treatment, suspended in an organic or inorganic solvent, in particular in water. Suitable materials for step (a), which form macropores especially after thermal treatment, are Al₂O₃.aq, TiO₂.aq, SiO₂.aq, ZrO₂.aq.

In one embodiment of the present invention, step (a) and subsequent thermal treatment form a layer of a material which forms macropores, in which case the layer may be in the range from 1 to 300 μm thick, preferably up to 100 μm.

In a specific embodiment of the present invention, the hydrogenation catalyst is prepared by a process which comprises the steps of
(b) impregnating with a compound of a metal of group 8-10 of the Periodic Table of the Elements,
(d) treating with acid.

In this case, step
(b) impregnating with a compound of a metal of group 8-10 of the Periodic Table of the Elements,
is carried out before step (c) and, if appropriate, after step (a). In addition, step
(d) treating with acid
is carried out after step (c) and before step (e).

Particular preference is given to impregnating in step (b) with a compound of Fe, Co or in particular Ni. Fe, Co and in particular Ni can preferably be deposited by impregnating the megaporous substrate, if appropriate after performing step (a), with a preferably aqueous solution of a compound of Fe, Co or in particular Ni, for example the sulfate, nitrate, chloride or acetate, for example contacting by spraying and preferably by saturating, then reacting with a reducing agent, for example urea (others) and then calcining, for example at temperatures in the range from 400 to 700° C.

For treatment with acid in step (d), mineral acid, for example hydrochloric acid, nitric acid, sulfuric acid, can preferably be selected, more preferably aqueous mineral acid, most preferably concentrated nitric acid or concentrated sulfuric acid.

In one embodiment of the present invention, treatment is effected in step (d), for example, for from 10 minutes to 12 hours with acid, preferably from one to 3 hours.

In one embodiment of the present invention, treatment is effected in step (d), for example, at a temperature in the range from 30 to 150° C., preferably around 100° C.

The process according to the invention makes it possible to obtain hydrogenated polymers with, for example, CH₂NH₂ groups or ethyl side groups in good space-time yield. When the process according to the invention is carried out, in particular, only a low degradation in the molecular weight of the hydrogenated polymer is observed. Another observation is that, in the case of the reaction of polymers which have C—C double bonds or C—N multiple bonds and also aromatic groups, for example phenyl rings, the phenyl rings are not attacked.

The invention is illustrated by working examples.

### Preliminary Remarks

The solvents used (tetrahydrofuran THF, 1,4-dioxane) were freed of water and any peroxides before use by known methods such as distillation over sodium/benzophenone.

Tests of the hydrogenation catalysts can be carried out in continuous apparatus. However, it is also possible to break up finished hydrogenation catalysts and to test them as pieces with a mean diameter of 125 μm in a batch experiment. The comparability of the results in the present cases is not impaired by the different experimental setup.

### I. Preparation of Polymers Which Have C—C Multiple Bonds Or C—N Double Bonds

### I.1 Polymer P1 (Styrene-Acrylonitrile Copolymer, 50:50% By Weight)

390 g of freshly distilled 1,4-dioxane were heated to 100° C. in a 2 I HWS vessel under a nitrogen atmosphere. Thereafter, metered addition was effected simultaneously from feed 1 consisting of 552 g of styrene, 552 g of acrylonitrile in 276 g of 1,4-dioxane, and feed 2, a solution of 55.2 g of tert-butyl peroctoate in 497 g of 1,4-dioxane. The metered addition lasted for 3.5 hours in each case. Subsequently, polymerization was continued at an internal temperature of 100° C. over a period of from two hours and excess residual monomer was subsequently distilled off under reduced pressure (50 to 500 mbar) at an external temperature of 100° C. for 2 hours, in the course of which the pressure was regulated so as to avoid excessive foaming. In the course of the distillation, a certain proportion of 1,4-dioxane was also distilled over.

A yellow viscous liquid having a solids content of 42.6% and a K value (1% by weight in THF, 25° C.) of 28.2 was obtained.

### I.2 Polymer P2 (Methyl Acrylate-Acrylonitrile Copolymer, 62:38% By Weight)

Tetrahydrofuran (THF, 810 g) was heated to boiling (65° C.) in a 2 I HWS vessel under a nitrogen atmosphere. Thereafter, metered addition was effected simultaneously from feed 1 consisting of 795 g of methyl acrylate, 490 g of acrylonitrile and 244 g of THF, and feed 2, a solution of 19.25 g of 2,2′-azobis(2,4-dimethylvaleronitrile) (commercially available as V-65 azo initiator from Wako Chemicals GmbH) in 244 g of THF. The metered addition lasted 3 hours in each case.

Subsequently, polymerization was continued at an internal temperature of 65° C. for two hours and excess residual monomer was distilled off under reduced pressure (50 to 500 mbar) at an external temperature of 65° C. for two hours, in the course of which the pressure was regulated such as to prevent excess foaming. In the course of distillation, a certain proportion of THF was also distilled over.

A yellow viscous liquid having a solids content of 64.3% and a K value (1% by weight in THF, 25° C.) of 17.8 was obtained.

### II. Preparation of Hydrogenation Catalysts

The starting material in each case was a ceramic monolith of cordierite, 2 MgO.5 SiO₂.2 Al₂O₃, with a length of 3.75 cm and a diameter of 1.8 cm and a cell density of 400 cpsi (cells per square inch), a length of 3.75 cm and a diameter of 1.8 cm. The porosity was 74%, the mean tubular diameter 1.1 mm and the internal surface area 2710 m²/m³.

The entire amount of monolith in each case was processed further in steps II.1 to II.6.

### III.1 Step (a): Washcoat

4.12 g of monolith from I. were weighed out. A suspension of 100 g of α-Al₂O₃, 0.9 g of formic acid and 150 g of H₂O was introduced into a 250 ml measuring cylinder. The amount of monolith from I. weighed out was immersed for 10 seconds and left to drip, the sides were stripped off with paper, and the monolith was blown through with air and dried with a hot air gun. The monolith was then calcined in a muffle furnace at 500° C. (2 hours).

This gave a monolith with a washcoat of α-Al₂O₃, also known as monolith from step II.1 for short. After thermal treatment, the layer thickness of α-Al₂O₃ was 30 μm.

### II.2 Step (b): Impregnation With A Compound of A Metal of Group 8-10 of the Periodic Table of the Elements

Monolith from step II.1 was covered in a 1000 ml glass flask with 500 ml of distilled water having a temperature of 90° C. 1.09 g of Ni(NO₃)₂.6 H₂O were added and a pH of 3.5 was established with nitric acid. Thereafter, 0.72 g of urea was added. The mixture was left to stand at 90° C. for 16 hours without stirring, then cooled to room temperature and filtered. The filter residue was washed three times with distilled water, dried at 120° C. for 16 hours and calcined at 600° C. in a rotary tube over a period of 3 hours. This gave a monolith with a washcoat of α-Al₂O₃ and a decomposition catalyst, also referred to as monolith from step II.2 for short.

### II.3 Step (c): Deposition of Carbon Nanofiber

Monolith from step II.2 was introduced into a quartz tube (dimensions: diameter 23 mm, length 860 mm) and reduced in a gas stream of a gas mixture of 20 l/h of hydrogen and 5 l/h of nitrogen. The gas stream was heated to 550° C. within two hours and then kept at 550° C. for 3 hours. The quartz tube was then purged with nitrogen and cooled to room temperature. 100 ml/min of a gas stream consisting of a mixture of 10% H₂, 70% N₂ and 20% CH₄ (data in each case in % by volume, determined at standard pressure) were then passed through the quartz tube. The gas stream was heated to 550° C. within a period of 2 hours and then kept at 550° C. for 5 hours. It was observed that carbon nanofibers were deposited on the monolith from step 11.2. Thereafter, the quartz tube was purged with nitrogen and cooled to room temperature. This gave monolith with a washcoat of α-Al₂O₃, a decomposition catalyst and carbon nanofibers (27.8% by weight of carbon based on monolith), also referred to as monolith from step II.3 for short.

### II.4 Step (d) Treatment With Acid

Monolith from step II.3 was boiled at reflux with 500 ml of 65% by weight aqueous nitric acid over a period of two hours, then withdrawn and washed three times with one liter of water each time.

This gave monolith with a washcoat of α-Al₂O₃ and carbon nanofibers, also referred to as monolith from step II.4 for short.

### II.5 Step (e): Impregnation With A Solution of At Least One Compound of A Metal Which Catalyzes Hydrogenations

Monolith from step II.4 was slurried in 500 ml of distilled water (90° C.) and a pH of 3.5 was established with nitric acid. 0.2 g of ruthenium nitrosylnitrate (Ru(NO)(NO₃)₃.H₂O) and 0.132 g of urea were added. The mixture was left to stand at 90° C. for 16 hours without stirring, then cooled to room temperature, and the liquid was poured off. The monolith thus treated was washed three times with distilled water, dried at 120° C. for 16 hours, reduced with a hydrogenous gas stream (20 l/h of H₂, 5 l/h of N₂) at 200° C. in a quartz tube over a period of one hour. The monolith was then heated with nitrogen to 300° C. over a period of one hour. It was then cooled to room temperature. This gave a hydrogenation catalyst, also known as hydrogenation catalyst from step II.5. The hydrogenation catalyst from step II.5 had a content of Ru of 0.32% by weight, based on monolith, and of 3.8% by weight, based on carbon nanofibers.

Hydrogenation catalyst from step II.5 could be passivated, for example by storing under air. The activation was then effected during the first minutes of the hydrogenation, and automatically with the aid of a reducing agent, specifically of hydrogen.

### III. Inventive Hydrogenation

### III.1 Inventive Hydrogenation of Polymer P1

150 g of polymer P1 were introduced into a 300 ml autoclave with stirrer and gas inlet tube as a 10% by weight solution in THF. 2 g of hydrogenation catalyst from step II.5 were broken up into small pieces (mean particle diameter dₚ about 125 μm) and likewise introduced into the autoclave. The autoclave was inertized with nitrogen. A Büchi unit was used to introduce hydrogen into the autoclave and a pressure of 50 bar was established at room temperature. The autoclave was heated to 200° C. and 200 bar of hydrogen were injected. Reaction was allowed to continue for 16 hours, then the autoclave was cooled to room temperature and decompressed.

For workup, the hydrogenation catalyst was filtered off with the aid of a fluted filter and the THF was distilled off on a rotary evaporator (60° C.→100° C., 300 mbar→10 mbar).

This gave a polymer P1 (red.) which no longer had any nitrile groups. All phenyl rings were intact; for example, no cyclohexyl groups whatsoever were detected.

### III.2 Inventive Hydrogenation of Polymer P2

150 g of polymer P2 were introduced into a 300 ml autoclave with stirrer and gas inlet tube as a 10% by weight solution in THF. 2 g of hydrogenation catalyst from step II.5 were broken up into small pieces (mean particle diameter dₚ about 125 μm) and likewise introduced into the autoclave. The autoclave was inertized with nitrogen. A Büchi unit was used to introduce hydrogen into the autoclave and a pressure of 50 bar was established at room temperature. The autoclave was heated to 200° C. and 200 bar of hydrogen were injected. Reaction was allowed to continue for 16 hours, then the autoclave was cooled to room temperature and decompressed.

For workup, the hydrogenation catalyst was filtered off with the aid of a fluted filter and the THF was distilled off on a rotary evaporator (60° C.→100° C., 300 mbar→10 mbar).

This gave a polymer P2 (red.) which no longer had any nitrile groups. The COOCH₃ groups were intact; for example, no CH₂OH groups were detected.

1. A process for hydrogenating polymers which have C—C double bonds or C—N multiple bonds, comprising contacting a hydrogenation catalyst with the polymers, wherein the hydrogenation catalyst comprises a megaporous substrate having a mean pore diameter in the range from 0.1 to 10 mm and a metal having a mean diameter in the range from 3 to 100 nm and a mean length in the range from 0.1 to 1000 μm, or precursor thereof, which catalyzes the hydrogenation and has been deposited onto carbon nanofibers.

2. The process according to claim 1, wherein the carbon nanofibers have been deposited on one or more monoliths as the megaporous substrate.

3. The process according to claim 1, wherein the hydrogenation catalyst is substantially free of pores having a diameter below 2 nm.

4. The process according to claim 1, wherein the polymers which have C—C double bonds or C—N multiple bonds are polymers or copolymers of acrylonitrile or 1,3-butadiene.

5. The process according to claim 1, wherein the megaporous substance is a monolith of a metallic or ceramic material.

6. The process according to claim 1, which is carried out at temperatures in the range from 100 to 300° C.

7. The process according to claim 1, which is carried out at a pressure in the range from 50 to 300 bar.

8. The process according to claim 1, which is carried out using a solvent which is liquid under the process conditions.

9. The process according to claim 1, wherein the hydrogenation catalyst is prepared by a process comprising:
(c) depositing carbon nanofibers on a megaporous substance,
(e) impregnating with a solution of at least one compound of a metal which catalyzes hydrogenations, and
(f) calcining.

10. The process according to claim 9, wherein the hydrogenation catalyst is prepared by carrying out, before step (c), a step of
(a) washcoating with a material which forms macropores.

11. The process according to claim 9, wherein the hydrogenation catalyst is prepared by carrying out, before step (c), the step of
(b) impregnating with a compound of a metal of group 8-10 of the Periodic Table of the Elements,
and after step (c) and before step (e), the step of
(d) treating with acid.

12. The process according to claim 10, wherein the hydrogenation catalyst is prepared by carrying out, after step (a), the step of
(b) impregnating with a compound of a metal of group 8-10 of the Periodic Table of the Elements,
and after step (c) and before step (e), the step of
(d) treating with acid.
